(19) United States
(12) Patent Application Publication
(10) Pub. No.: US 2011/0041942 A1
(43) Pub. Date: Feb. 24, 2011

(54) Method for the production of concrete pipes and concrete pipe system

(75) Inventors: Johann Bartlechner, Kirchweidach (DE); Franz Bartlechner, Kirchweidach (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Johann Bartlechner KG, Kirchweidach (DE)

(21) Appl. No.: 12/921,552

(22) PCT Filed: Mar. 11, 2009
(86) PCT No.: PCT/EP2009/001740

§ 371 Date: Nov. 4, 2010

(30) Foreign Application Priority Data
Mar. 12, 2008 (DE) 10 2008 013 768.5

(51) Int. Cl. F16L 9/08; B28B 1/14

(52) U.S. Cl. 138/111; 264/278

(57) ABSTRACT

The invention relates to a method for the production of concrete pipes, particularly for wastewater lines, having a plastic inner pipe, wherein the concrete part is manufactured in a horizontal position in order to simplify the production process and reduce the costs thereof, and wherein the plastic inner pipe is maintained in a horizontal position in a trough, wherein the trough is further filled with flowable concrete to above the plastic pipe, and wherein the plastic pipe serves as an inner tray and remains in the concrete pipe after the concrete has cured, and to a concrete pipe system.

The present invention relates to a method for the manufacture of concrete pipes, in particular for waste water lines, having a plastic inner pipe.

The present invention furthermore relates to a concrete pipework system, in particular as waste water pipework, having concrete pipes which abut one another at their end faces in the laid state.

Concrete pipes are usually produced in standing manner. This means that a formwork corresponding to the outer shape of the concrete pipe to be produced is set up such that the longitudinal axis of the pipe to be produced is perpendicular. Internal formwork is inserted into this external formwork, said internal formwork corresponding to the inner shape of the pipe to be produced and having a spacing from the external formwork corresponding to the wall thickness of the pipe. Concrete is then poured into the intermediate space. After sufficient hardening of the concrete, the outer shell, which is usually made in two parts, is removed. The inner shell is likewise removed which is made reducible in diameter for this purpose.

The plastic pipe is pushed onto the core, that is onto the inner shell, for the manufacture of concrete pipes having a plastic inner pipe, a so-called inner liner. The inner pipe connects to the concrete poured in, with naps being used for better anchoring with larger pipes.

It is the underlying object of the invention to improve the manufacture of concrete pipes having a plastic inner pipe. The effort and/or costs should in particular be improved and the manufacturing time cut.

It is furthermore the underlying object of the invention to provide a concrete pipe which can be laid more easily.

The first object is satisfied in that the concrete pipe is produced in lying manner, with a trough serving as the outer shell, in that the plastic inner pipe is held horizontal in the trough and in that the trough is then filled up to and above the plastic pipe with flowable concrete, with the plastic pipe serving as an internal shell and remaining in the concrete pipe after the hardening of the concrete.

The second object is satisfied in that the end faces of the concrete pipes have mutually flush receivers in the laid state into which the pins can be inserted which connect the mutually abutting pipes with one another, and in that at least one inner pipe stub is provided which engages into the two mutually abutting ends of the concrete pipes.

The concrete pipe is therefore produced in lying manner in accordance with the invention. A plurality of advantages thereby result. On the one hand, a trough can be used as an outer shell, that is a single-part mold. Furthermore, the filling is simplified since it is not necessary, as in the standing process, to fill the ring gap between the outer shell and the inner shell. The total opening width of the trough is rather available as a filling opening. The manufacture is thereby already considerably simplified and accelerated.

Further advantages result by the use of the plastic inner pipe as an inner shell. On the one hand, it is no longer necessary to remove the inner shell. In addition the cleaning of the inner shell is dispensed with. A very advantageously manufacturing process therefore results overall for concrete pipes of the named kind.

The plastic inner pipe, which simultaneously serves as an inner shell, is preferably held via the end plates of the trough. The end plates, which are anyway necessary to close the outer mold at the ends of the pipe, thereby have a further function. Separate holding means can be dispensed with.

To facilitate the demolding of the manufactured concrete pipe, the end plates of the trough are preferably made in releasable manner. After sufficient hardening of the concrete, the end plates are removed. The finished concrete pipe can then be removed particularly easily.

After the removal of the finished pipe from the trough, the trough is cleaned and is then closed with the end plates again. A concrete pipe can then again be manufactured, with a plastic inner pipe again being used as the inner shell.

The trough is preferably made such that it constantly converged downwardly. On the one hand, a good and complete filling of the trough is hereby ensured. On the other hand, the removal of the finished pipe from the trough is facilitated.

In accordance with a further embodiment of the invention, a plurality of troughs are combined to form a unit and are simultaneously used for the manufacture of concrete pipes. The manufacturing time for a concrete pipe can hereby be further cut and the productivity can be further increased.

In accordance with a special embodiment of the invention, the trough is made without a step in the two end regions. Concrete pipes can hereby be manufactured which have no spigot end and no muff end, that is are made straight.

Pins can be inserted into the end faces of the pipes for the connection of such straight pipes. The pins can either already be cast into one side of the concrete pipe during the manufacture, while corresponding receivers are introduced into the end face wall at the other end. Another possibility comprises introducing pin receivers into both ends and to insert the pins into the finished concrete pipes. For this purpose, in accordance with an embodiment of the invention, corresponding pins are provided in the end face walls of the trough which either remain in the concrete pipe or are pulled out of the pipe after the hardening. Plastic sleeves can also be placed onto the pins and remain in the receivers and line them after the demolding.

In accordance with an embodiment of the invention, the plastic inner pipe is radially expanded in at least one end region, preferably in both end regions, for which purpose the concrete pipe has a corresponding step at its associated end. Such an expanded portion allows the insertion of an inner pipe stub. This serves for the sealing of the piper interior to the outside with a muff-free connection. A throughgoing inner diameter of the concrete pipe can be ensured by the radial expansion of the plastic inner pipe despite the inner pipe stub.

In accordance with a preferred embodiment of the invention, a support core for the plastic inner pipe is introduced into the plastic inner pipe. This support core has the advantage that the plastic inner pipe cannot deform on the introduction of the concrete into the trough. The plastic inner pipe can thereby be made particularly thin, whereby cost advantages result.

The support core is in particular made as a spreading core which is introduced into the plastic inner pipe and is expanded before the concrete is poured in and which is reduced in diameter again after the hardening of the concrete and is removed from the core. An easy introduction and an easy removal of the support core is thereby possible and the support core can always be reused.

The support core preferably comprises a steel or aluminum pipe, in particular slotted. These materials have been found to be particularly suitable.

The plastic inner pipe and the support core are, in accordance with a further embodiment of the invention, introduced into the trough together and are held via the end plates. The plastic pipe can in particular be pushed onto the support core and the latter can then be expanded before both are inserted into the trough together. They are there first connected to an end plate which supports the plastic inner pipe and the support core and the second end plate is then attached which holds the plastic inner pipe and the support core at the other end.

The concrete pipework system in accordance with the invention with an inner pipe stub and a pin connection has the advantage that no muff and spigot ends have to be provided. The outer diameter of the concrete pipes is thereby constant over the total pipe length. Accordingly, no recess has to be provided for the muff ends on the laying of the pipe. In addition, the pipes can be connected to one another in both possible orientations since both ends are made the same.

The use of the pins in the end face walls provides a secure connection of the mutually abutting pipes. A particularly stable connection and a clear positioning of the pipes with respect to one another results from the use of at least three pins arranged over the end face of the pipes. However, only two pins can also be used, in particular in the region of the end face. An easy tilting of two connected pipes with respect to one another is thereby made possible.

In order also to be able to take up high forces, the pins are preferably made from metal. They can in this respect also be provided with an elastic coating to take up slight tilts or twists of the mutually abutting pipes relative to one another. In addition or alternatively, plastic sleeves which line the receivers can be inserted into the pin receivers. The plastic sleeves can also be made from an elastic material which can take up slight tilts or twists of the mutually abutting pipes relative to one another.

In accordance with a further embodiment of the invention, the pins have a ring-shaped expanded portion in the center as an abutment for the two pipe ends. The abutment is thereby precisely defined and an abutment of concrete on concrete is avoided.

The inner pipe stub is preferably made from plastic. The total pipe, including the transition region, can thus have a plastic inner pipe. The forces which occur are taken up by the pins which are preferably made of metal. The inner pipe stub therefore essentially does not have to take up any forces.

To ensure a sealing of the pipe interior toward the outside, a respective seal is preferably provided between the inner pipe stub and the two abutting concrete pipes. A ring seal can in each case in particular be provided between the inner pipe stub and the expanded plastic inner pipe. A particularly good sealing thus results.

The concrete pipe is preferably expanded at the end face to receive the inner pipe stub. A throughgoing inner diameter of the pipe can thus be ensured.

In accordance with a special embodiment of the invention, the concrete pipes are provided with a plastic inner pipe, a so-called inner liner. Concrete pipes with inner liners are advantageous for specific applications.

The plastic inner pie is also preferably expanded at the end face to ensure a throughgoing inner diameter of the pipe on the use of an inner pipe stub.

Embodiments of the invention are shown in the drawing and will be described in the following. There are shown in a schematic representation in each case

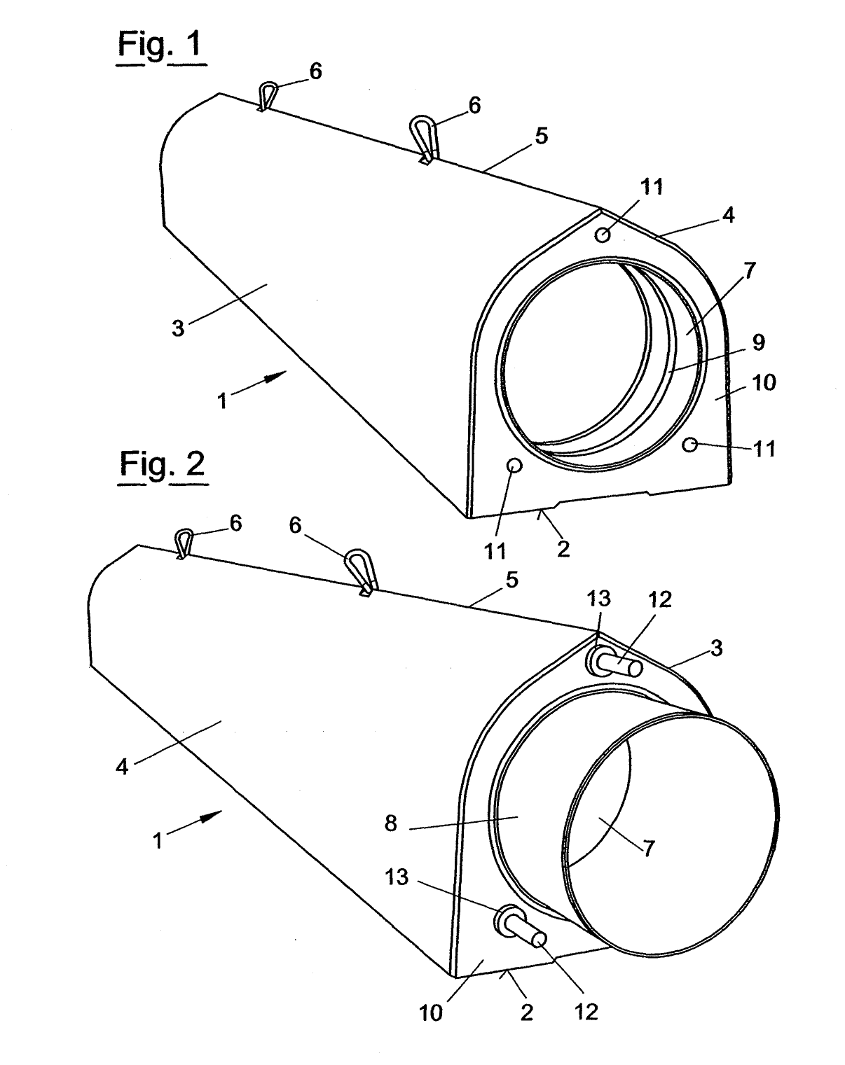

FIG. 1 a perspective view of the first end of a concrete pipe in accordance with the invention;

FIG. 2 a perspective view of the other end of the concrete pipe of FIG. 1;

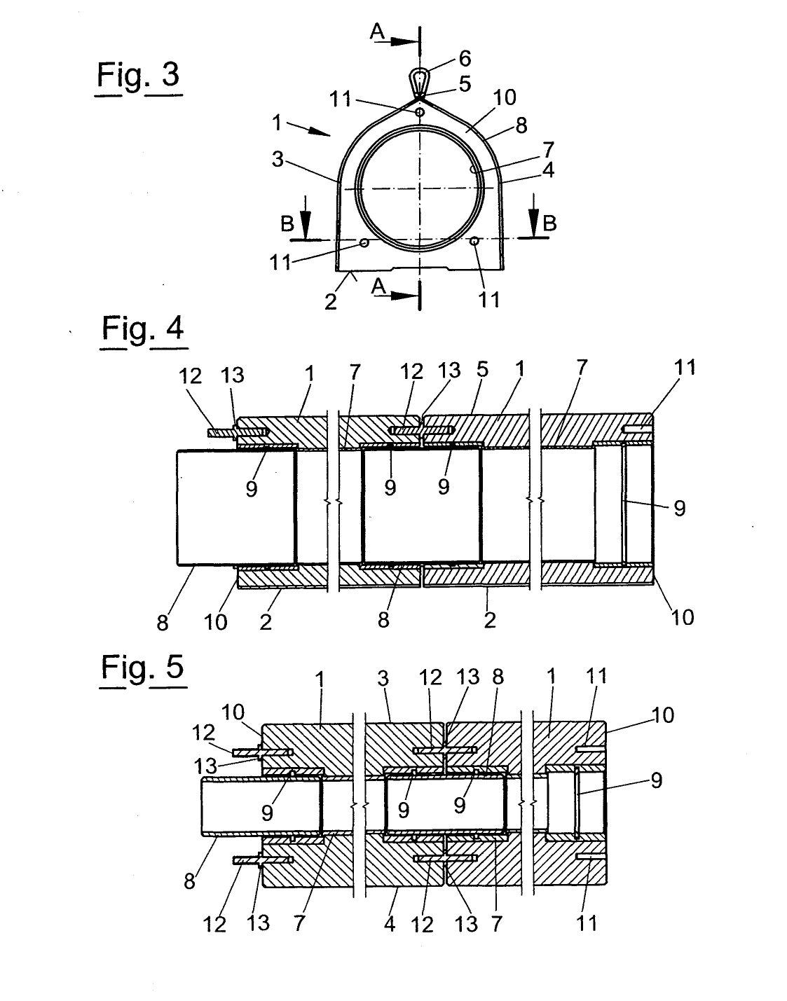

FIG. 3 a plan view of the end face of the concrete pipe of FIG. 1;

FIG. 4 a section in accordance with the line A-A in FIG. 3;

FIG. 5 a section in accordance with the line B-B in FIG. 3;

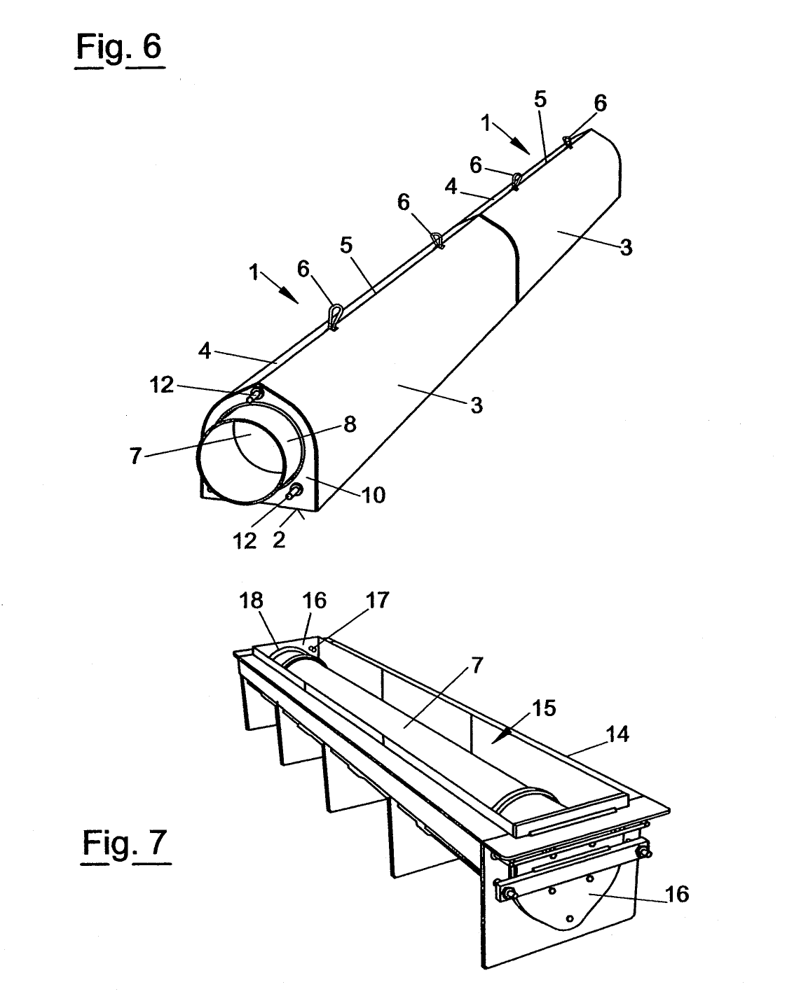

FIG. 6 a perspective view of two joined concrete pipes in accordance with the invention;

FIG. 7 a perspective view of a trough for the manufacture of a concrete pipe in accordance with the invention;

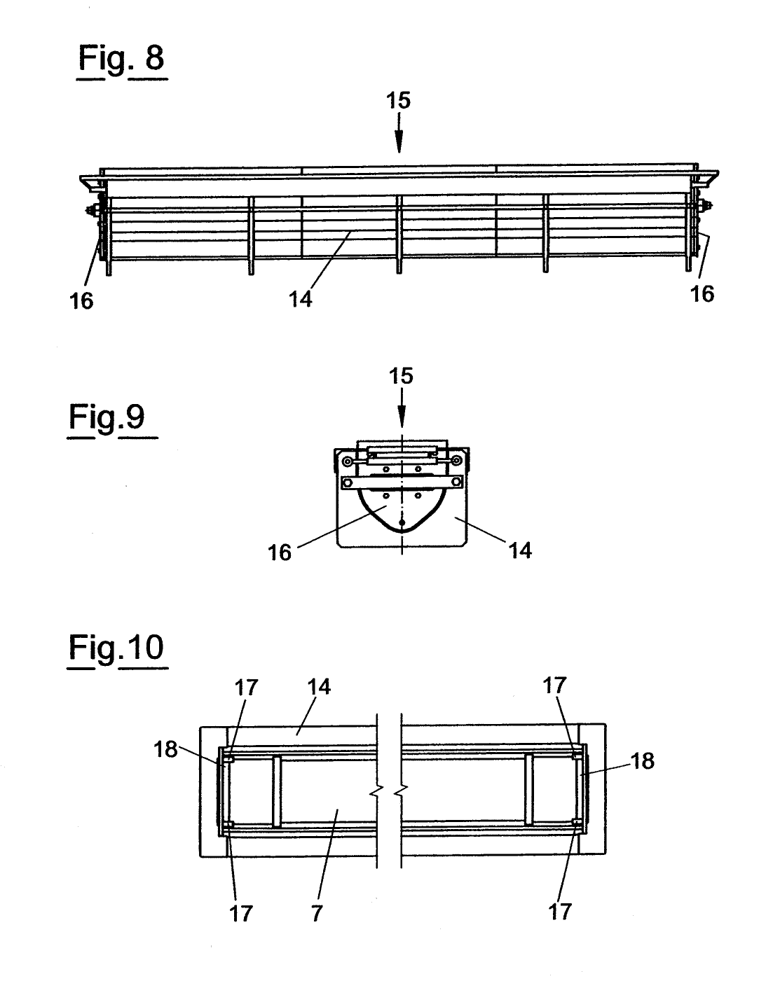

FIG. 8 a side view of the trough of FIG. 7;

FIG. 9 a plan view of the end face of the trough of FIG. 7;

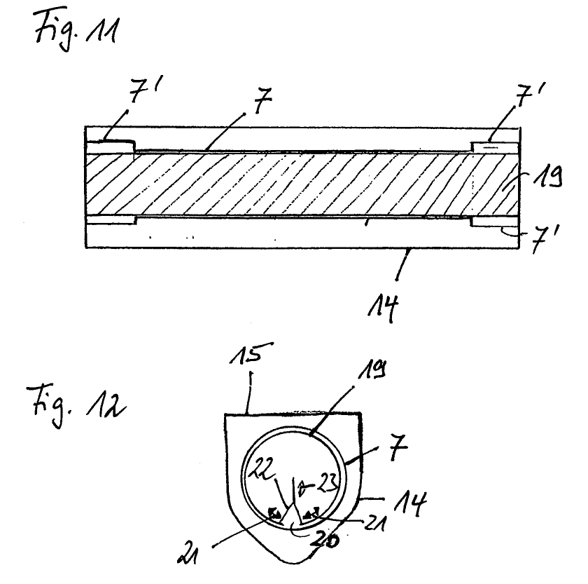

FIG. 10 a plan view of the upper side of the trough of FIG. 7;

FIG. 11 a plan view of a trough in a variant of the invention; and

FIG. 12 a plan view of the end face of the trough of FIG. 11.

The concrete pipe 1 shown in the Figures has a substantially straight lower side 2 as well as two sides 3 and 4 which initially extend upwardly straight from the lower side 2 and then toward one another in an arc shape, with them forming a crest 5 in the center of the concrete pipe 1. Two support loops 6 are inserted in the region of the crest 5 into the upper side of the concrete pipe 1.

It can be recognized in FIG. 1 that the concrete pipe 1 has an inner diameter circular in cross-section. A corresponding plastic inner pipe, a so-called inner liner 7. is inserted into the interior of the concrete pipe 1. The concrete pipe 1 and the inner liner 7 are radially expanded in the two end regions. As shown in FIG. 2, an inner pipe stub 8 is inserted into this expanded portion. This inner pipe stub 8 thus extends into both pipes with mutually abutting pipes 1. As can be recognized in FIG. 1, a ring seal 9 is provided between the inner pipe stub 8 and the inner liner 7.

The two end faces 10 of the concrete pipe 1 are provided with three receivers 11 for pins 12 (see FIG. 2). Two of the receivers 11 are located in the region of the lower side 2 of the concrete pipe and the third receiver is located in the region of the crest 5. The pins 12 which are shown inserted into the receivers 11 in FIG. 2 have a ring-shaped expanded portion 13 in their center which serves as an abutment. They are preferably made from metal and are provided with an elastic coating. Only two pins can also be inserted, in particular into the two lower receivers 11. Plastic sleeves. not shown here—can also be inserted into the receivers 11 to line the receivers 11, with the sleeves also being able to be made of an elastic material.

As can be seen in FIG. 6, concrete pipes 1 can mutually abut one another by the receivers 11 and pins 12 as well as the inner pipe stub 8, without the concrete pipes having to have a spigot end and a muff end. The pipes are rather, as shown, formed with a constant outer periphery over their length. The forces between the pipes 1 are above all taken up by the pins 12 which simultaneously ensure an exact positioning of the pipes 1 with respect to one another. The sealing of the pipe interior toward the outside takes place via the inner pipe stubs 8 and the sealing rings 9.

FIG. 7 shows a mold for the manufacture of the concrete pipe shown in FIGS. 1 to 6. The mold includes a trough 14 with an upper opening 15. The trough 14 converges constantly downwardly in accordance with the outer shape of the concrete pipe 1.

The trough 14 has end plates 16 at the end faces which are releasably connectable to the trough 14. Projecting pins 17 are provided in the end plates and correspond to the receivers 11 in the end plates of the concrete pipe 11. Plastic sleeves—not shown here—can be placed onto the pins 17 and remain in and line the receivers 11 on the demolding of the concrete pipe 7. In addition, the end plates 16 have holders 18 for the plastic inner pipe 7 via which the plastic inner pipe 7 can be held as an inner shell.

After the attachment of the end plates 16 with an inserted plastic inner pipe 7, the mold shown in FIGS. 7 to 10 is already ready for the manufacture. Flowable concrete is poured into the opening 15 from above and flows around the plastic inner pipe 7 and fills the total trough 14. The concrete is filled up to and above the plastic inner pipe 7, in particular up to the upper rim of the trough 14. After sufficient hardening of the concrete, the end plates 16 are released and the finished concrete pipe 1 is removed together with the inner pipe 7. The manufacturing process can be begun again after cleaning the trough 14 and the end plates 16.

In the variant shown in FIGS. 11 and 12, a spreading core 19 is present within the plastic inner pipe which supports the plastic inner pipe 7. The spreading core 19 is supported, together with the plastic inner pipe 7, by the two end plates not shown here. The spreading core 19 is made, for example, from a steel pipe or an aluminum pipe which is provided with a longitudinal slot 20. The spreading core 19 can thereby be increased and reduced in diameter, which is indicated in FIG. 12 by arrows 21. The increasing and decreasing of the diameter of the spreading core 19 takes place in a known manner, for example by limbs 22 which extend toward the center of the spreading core 19 and which are movable to and fro in accordance with the arrow 23.

It can additionally be recognized in FIG. 11 that the plastic inner pipe 7 has a respective expanded portion 7′ at its two ends. It serves the purpose, as previously described, of receiving an inner pipe stub 8.

As results from the above, the lying production in accordance with the method in accordance with the invention is possible extremely fast and simply. A high productivity and low costs thereby result. Self-compacting concrete is preferably used as the concrete. Conventional concrete can, however, also be used, with the mold 14 then being shaken after the pouring in of the concrete. The stripping can take place in dependence on the type of concrete substantially directly after the filling of the trough 14 or only after a corresponding drying time. In addition, a plurality of troughs 14 can be combined to units so that a plurality of concrete pipes 1 can be produced simultaneously. The troughs 14 are then filled with concrete simultaneously by a corresponding apparatus. The production time of a pipe can thereby be further cut again.

The advantage additionally results by the production with one trough 14 that a straight side is obtained. This side can serve as a lower side 2 of the pipe 1 which can thereby be easily supported on a planar surface. The manufacture of ditches for the concrete pipes 1 in accordance with the invention can thus also be facilitated.

### REFERENCE NUMERAL LIST

1 concrete pipe
2 lower side
3 side surface
4 side surface
5 crest
6 support loop
7 plastic inner pipe
8 inner pipe stub
9 sealing ring
11 receiver
12 pin
13 expanded portion of 12
14 trough
15 opening of 14
16 end plate
17 pin
18 holder
19 spreading core
20 slot
21 arrow
22 limb
23 arrow

1-26. (canceled)

27. A method for the manufacture of concrete pipes, in particular for waste water pipework, having a plastic inner pipe (7),
characterized in that
the concrete pipe (1) is produced in lying manner, with a trough (14) serving as an outer shell; in that the plastic inner pipe (7) is held horizontal in the trough (14); and in that the trough is filled with flowable concrete up to and above the plastic pipe (7), with the plastic pipe (7) serving as an inner shell and remaining in the concrete pipe (1) after the hardening of the concrete.

28. A method in accordance with claim 27, characterized in that the plastic inner pipe (7) is held via the end plates (16) of the trough (14).

29. A method in accordance with claim 27, characterized in that the end plates (16) of the trough (14) are made releasable; and in that the end plates (16) are removed after sufficient hardening of the concrete.

30. A method in accordance with claim 29, characterized in that the concrete pipes (1) are removed from the trough (14) after removal of the end plates (16) and sufficient hardening; and in that the trough (14) is then cleaned and closed by the end plates (16).

31. A method in accordance with claim 27, characterized in that the trough (14) converges constantly downwardly.

32. A method in accordance with claim 27, characterized in that the trough (14) is filled with self-compacting concrete.

33. A method in accordance with claim 27, characterized in that a plurality of troughs (14) are combined to a unit and are filled with concrete simultaneously.

34. A method in accordance with claim 27, characterized in that the trough (14) is made without a step in the two end regions.

35. A method in accordance with claim 27, characterized in that pins (17) which face toward the trough interior and which extend outside the plastic inner pipe (7) are provided in at least one end plate (16), preferably in both end plates (16), of the trough.

36. A method in accordance with claim 35, characterized in that plastic sleeves which remain in the pipe (7) on the demolding of the plastic pipe (7) are placed onto the pins (17).

37. A method in accordance with claim 27, characterized in that the plastic inner pipe (7) is radially expanded in at least one end region, preferably in both end regions, for which purpose the concrete pipe (1) has a corresponding step at its respective associated end.

38. A method in accordance with claim 27, characterized in that a support core (19) for the plastic inner pipe (7) is introduced into the plastic inner pipe (7).

39. A method in accordance with claim 38, characterized in that the support core (19) is made as a spreading core which is introduced into the plastic inner pipe (7) and is expanded before the concrete is poured in and which is reduced in diameter again after the hardening of the concrete and is removed from the plastic inner pipe (7).

40. A method in accordance with claim 38, characterized in that the support core (19) is formed from a steel pipe or aluminum pipe, in particular slotted.

41. A method in accordance with claim 38, characterized in that the plastic inner pipe (7) and the support core (19) are introduced into the trough (14) together and are held via the end plates (16).

42. A concrete pipework system, in particular as waste water pipework, having concrete pipes (1) which abut one another at the end faces in the laid state,
characterized in that
the end faces (10) of the concrete pipes (1) have receivers (11) which coincide with one another in the laid state and into which pins can be inserted which connect the mutually abutting pipes (1) to one another; and in that at least one inner pipe stub (8) is provided which engages into the two mutually abutting ends of two concrete pipes (1).

43. A concrete pipework system in accordance with claim 42, characterized in that at least two receivers for pins (12) are provided arranged distributed over the end face (10) of the pipes (10).

44. A concrete pipework system in accordance with claim 42, characterized in that the pins (12) are made of metal.

45. A concrete pipework system in accordance with claim 42, characterized in that the pins (12) have an elastic coating.

46. A concrete pipework system in accordance with claim 42, characterized in that the pins (12) have a ring-shaped expanded portion (13) at their center as an abutment for the two pipe ends.

47. A concrete pipework system in accordance with claim 42, characterized in that plastic sleeves, in particular of elastic material, are inserted into the receivers (11).

48. A concrete pipework system in accordance with claim 42, characterized in that the inner pipe stub (8) is made of plastic.

49. A concrete pipework system in accordance with claim 42, characterized in that a respective seal (9) is provided between the inner pipe stub (8) and the two abutting concrete pipes (1).

50. A concrete pipework system in accordance with claim 42, characterized in that the concrete pipes (1) are expanded at the end face for the reception of the inner pipe stubs (8).

51. A concrete pipework system in accordance with claim 42, characterized in that the concrete pipes (1) have a plastic inner pipe (7).

52. A concrete pipework system in accordance with claim 51, characterized in that the plastic pipe (7) is likewise expanded at the end face.
